(19) United States
(12) Patent Application Publication
(10) Pub. No.: US 2026/0274642 A1
(43) Pub. Date: Sep. 17, 2026

(54) CONNECTOR FOR BEVERAGE DISPENSE LINE

(71) Applicant: Carlsberg Breweries A/S, Copenhagen V (DK)

(72) Inventors: Klaus Laybourn, Copenhagen V (DK); Niklas Ingemansson, Copenhagen Ø (DK)

(73) Assignee: Carlsberg Breweries A/S, Copenhagen V (DK)

(21) Appl. No.: 18/873,926

(22) PCT Filed: Jul. 26, 2023
(86) PCT No.: PCT/EP2023/070675

§ 371 Date: Dec. 11, 2024

(30) Foreign Application Priority Data
Jul. 27, 2022 (EP) 22187142.9

(51) Int. Cl. B67D 1/14; B67D 1/04; B67D 1/06; B67D 1/08

(52) U.S. Cl. CPC B67D 1/1405; B67D 1/0462; B67D 1/06; B67D 1/0829

(57) ABSTRACT

A connector for connecting a beverage dispensing line to a beverage container, the connector including a central passageway; a flange; an annular first wall extending from a central portion of the flange; and a first ring extending from the first wall and configured to provide a fluid-tight interlocking connection with a corresponding annular apron of a closure of the beverage container when the connector and the closure are pushed together along the central axis. An annular skirt extends from the peripheral portion of the flange and surrounds the first wall and the first ring for providing protection and grasping surface for removing the connector from the closure.

### TECHNICAL FIELD

The disclosure relates to a beverage dispensing system for dispensing a beverage, and more particularly to a connector for connecting a beverage dispensing line to a beverage container.

### BACKGROUND

Conventional beverage dispensing systems intended for professional or private use such as the DraughtMaster™ system produced by the applicant company are described in e.g., WO 2007/019848, WO 2007/019849, WO 2007/019850, WO 2007/019851 and WO 2007/019853.

Beverage dispensing systems are typically used in beverage dispensing establishments for efficiently dispensing large quantities of beverage, including carbonated alcoholic beverages such as draught beer and cider, non-alcoholic beverages such as soft drinks and non-carbonated beverages such as wine and fruit juice. Beverage dispensing systems are mostly used by professional users in establishments like bars, restaurants and hotels, however, increasingly by private users in private homes and in smaller establishments.

Some beverage dispensing systems, such as the above mentioned DraughtMaster™ system, use a lightweight, collapsible and disposable beverage container or keg for accommodating the beverage and a pressurizing system for allowing the beverage flow from the container to the tapping system. The collapsible beverage container is typically made of thin and flexible plastic material and may even be in the form of a plastic bag. Such beverage dispensing systems using collapsible beverage kegs can have the beverage keg placed in a pressure chamber. Thus, while conventional steel kegs need to be pressurized internally using a CO₂ source, for instance by means of a CO₂-cartridge connected to the keg during dispensing, single-use beverage systems such as the applicant's DraughtMaster™ uses air from a separate pressure source, e.g. an air compressor, to push the beer out and collapsing the keg, which means that the beer is not exposed to any source of contamination from when it leaves the brewery until it exits the tapping head through a spout. While performing the dispensing operation, the pressure applied causes the beverage to flow out of the beverage keg and into a dispensing line. The dispensing line leads to a tapping head comprising a tap handle. The tap handle allows the operator to control the tapping valve and thereby the beverage dispensing operation. Typically, the tap handle is a part of a beverage font mounted in a bar, or when using a smaller beverage dispensing system, the tap handle is typically mounted on a housing of the beverage dispensing system, and typically in front of the keg, so that the tap handle may be easily used by the operator to dispense the beverage.

For hygienic reasons all parts in a beverage dispense system contacting the beverage must be handled in a sterile way to avoid dirt and bacteria to enter the beverage. Therefore, in most beverage dispensing systems intended for private users and smaller establishments the beverage container, as well as the dispensing line and the tapping valve are for single use only. In this way the beverage can be kept away from any possible contaminants during storage and dispensing. To ensure that the sterility of the parts contacting the beverage is maintained, it is generally not recommended to disassemble the parts contacting the beverage, i.e. disconnecting the dispensing line from the container or the tapping valve from the tapping line, since such disconnections would normally compromise the sterile environment of the beverage. If the dispensing line and valve is separate from the keg and not replaced together, after a certain amount of time a layer of residual beverage may be formed inside. While the spout portion is usually easier to clean as it is protruding from the tapping head, layers of residual beverage may solidify and eventually clog the dispensing line and/or the tapping valve that are more difficult to access and clean as they are located inside the tapping head and the font assembly. This buildup of residue can eventually impair the beverage dispensing operation. However, even before clogging the dispensing line and/or tapping valve, the residual beverage could pose a hygienic problem, since the dispensing line and the tapping valve constitute areas where bacterial growth may be accelerated due to the presence of beverage, the large surface area in comparison to the beverage volume, the lack of sufficient cooling and the close proximity to the environment.

For this reason, some beverage dispensing systems use dispensing lines firmly attached or integrated with the kegs to make sure they are replaced together, thus avoiding the above hygienic and/or mechanical problems. However, such systems have certain drawbacks.

For one, the dispensing line needs to be integrated or attached to the keg before delivery to the customer, which reduces the interchangeability between different types of kegs and dispensing lines and can be more susceptible to problems arising during transportation, ultimately leading to a compromised connection between the keg and the dispensing line.

Another issue with such integrated systems is that the beverage container needs to be installed in the beverage dispensing device with the dispensing line already attached, which can be a difficult task for a non-professional customer and can further lead to a hygienically compromised system.

Some existing solutions employ a removable connection between the keg and the dispensing line. However, these solutions usually require complex mechanical arrangements and separately provided tools for engaging and disengaging the connection between the keg and the dispensing line.

There is thus a need for a beverage dispense system where the beverage dispensing line and beverage container can be installed and replaced in an easy and user-friendly manner, while still ensuring a hygienical and mechanically uncomplicated connection between the dispensing line and the beverage container.

### SUMMARY

It is an object of the present disclosure to provide an improved beverage dispensing system that aims to solve at least some of the problems mentioned above.

The foregoing and other objects are achieved by the features of the independent claims. Further implementation forms are apparent from the dependent claims, the description and the figures.

According to a first aspect, there is provided a connector for connecting a beverage dispensing line to a beverage container, the connector comprising a keg connector end for connecting to a closure of a beverage container; a line connector end for connecting to a beverage dispensing line; and a central passageway extending along a central axis of the connector between the keg connector end and the line connector end. The keg connector end comprises a flange comprising a central portion surrounding the central passageway and a peripheral portion surrounding the central portion; a fluid-tight, annular first wall extending from the central portion of the flange and surrounding a first distal end of the central passageway; and a fluid-tight, annular first ring extending from the first wall and surrounding a disc-shaped first recess.

The connector according to this aspect enables a mechanically simple interlocking connection between a beverage dispensing line and a beverage container which can be engaged automatically by using the same pressure source from a beverage dispensing device that is used for collapsing the beverage container and thus not requiring any additional steps of intervention from the user.

The arrangement of the connector also enables a fluid-tight connection with less complexity and materials than the prior art solutions, since no separate gasket is needed between connector and the closure of the beverage container. This allows the entire connector to be easily mass-produced from as a single-piece plastic element, for example by injection molding, or even 3D printing.

In a possible implementation form of the first aspect wherein the keg connector end further comprises an annular skirt extending from the peripheral portion of the flange and surrounding the first wall and the first ring.

In a possible implementation form of the first aspect the skirt extends further from the flange than the first wall and the first ring.

In a possible implementation form of the first aspect the skirt extends from the flange to define an inner skirt wall towards the first wall, and an opposite outer skirt wall, wherein at least the outer skirt wall comprises a corrugated surface.

In a possible implementation form of the first aspect the skirt comprises a second ring arranged at a distal end opposite from the flange, the diameter of the second ring being larger than the diameter of the flange.

In a possible implementation form of the first aspect the skirt comprises at least one cut-out segment, and at least one solid segment arranged intermittently with said at least one cut-out segment to connect the flange with a second ring arranged at a distal end of the skirt opposite from the flange.

In a possible implementation form of the first aspect the first wall comprises a first wall flange arranged at its distal end from the flange, the first wall flange having a larger outer diameter than the first wall, and wherein the first ring extends from the periphery of the first wall flange.

In a possible implementation form of the first aspect the connector comprises at least one support wall extending from the first wall between the flange and the first wall flange for structural support of the first ring and the first wall flange when engaging with a surface of a closure of a beverage container.

In an embodiment a plurality of support walls extends radially from the first wall.

In an embodiment four support walls are arranged at angles of 90° extending radially from the first wall.

In a possible implementation form of the first aspect the first ring extends from the first wall to define an inner ring wall towards the first recess, and an opposite outer ring wall, the inner ring wall extending in parallel with the outer ring wall.

In an embodiment the inner ring wall and the outer ring wall extends in parallel with the central axis.

In a possible implementation form of the first aspect the first ring comprises a rounded first rim for engaging with a surface of a closure of a beverage container.

In a possible implementation form of the first aspect the connector further comprises at least one rib extending radially from the outer wall of the line connector end, the at least one rib comprising an outer rib surface facing radially outwards from the line connector end for engaging with a corresponding support surface of a beverage dispensing device.

In an embodiment the at least one rib extends between from the line connector end to the flange in an outwardly tapered shape towards the flange.

In an embodiment the connector comprises a plurality of ribs extending radially from the outer wall.

In an embodiment the connector comprises a plurality of ribs extending from the outer wall, with a first group of ribs extending in parallel to each other, and in parallel with a mold separation direction of the connector.

In an embodiment a further second group of ribs extends perpendicular to the mold separation direction of the connector.

In a possible implementation form of the first aspect the at least one rib comprises snap-lock means arranged on the outer rib surface for enabling a snap-lock interlocking engagement with a corresponding support surface of a beverage dispensing device.

In a possible implementation form of the first aspect the first recess is arranged with a first diameter d1, the central passageway is arranged with a second diameter d2, and wherein the first diameter is larger than the second diameter d1>d2.

In a possible implementation form of the first aspect a second distal end of the central passageway at the line connector end is arranged with a third diameter d3 that is larger than a second diameter d2 of the rest of the central passageway d3>d2, thereby defining a first adapter recess shaped to receive a first line adapter arranged around a distal end of a beverage dispensing line of a fourth diameter d4, the fourth diameter substantially corresponding to the second diameter d4=d2.

In an embodiment the third diameter d3 of the adapter recess is smaller than the first diameter of the first recess d3<d1.

In a possible implementation form of the first aspect the connector is a solid, single-piece item.

In an embodiment the connector is made from plastic, preferably recyclable polypropylene such as PP RJ377 MO.

In an embodiment the connector is mass manufactured via injection molding.

In a possible implementation form of the first aspect the connector comprises at least one annular gasket arranged on or around the flange, the first wall and/or the first ring, for providing additional sealing for a fluid-tight connection with a closure of a beverage container.

According to a second aspect, there is a provided beverage dispensing line for a beverage container, the beverage dispensing line comprising:
a valve line end comprising a dispensing line valve for selectively allowing or blocking flow of beverage through the dispensing line; and
a connector line end comprising a connector according to any one of the possible implementation forms of the first aspect for connecting the beverage dispensing line to a beverage container.

The beverage dispensing line according to this aspect allows connection to a beverage container automatically by using the same pressure source from a beverage dispensing device that is used for collapsing the beverage container and thus not requiring any additional steps of intervention from the user, while at the same time allowing dispensing of a beverage through the valve. The connection with the beverage container is strong enough to keep the dispensing line attached to the closure of the beverage container while removing from a beverage dispensing device, but not too strong so that it can still be removed from the beverage container manually without the need of additional tools.

In a possible implementation form of the second aspect the dispensing line valve is connected to the valve line end via a second line adapter arranged around the valve line end and shaped to snap-fit into a correspondingly shaped second adapter recess arranged in the dispensing line valve.

In a possible implementation form of the second aspect the connector line end comprises a connector being connected to the connector line end via the first line adapter arranged around the connector line end and shaped to snap-fit into the correspondingly shaped first adapter recess arranged at the line connector end of the connector.

In an embodiment the first line adapter and the second line adapter are different and non-interchangeable.

In another possible embodiment the first line adapter and the second line adapter are identical and interchangeable.

According to a third aspect, there is provided a connector kit for connecting a beverage dispensing line to a beverage container, the kit comprising:
a connector according to any one of claims 1 to 15; and
a closure for a beverage container, the closure comprising: coupling means for firmly and sealingly connecting the closure to a beverage container at a beverage outlet opening thereof;
a beverage valve for selectively allowing or blocking flow of beverage from the beverage outlet through the closure;
a fluid-tight, annular second wall surrounding the beverage valve and comprising a second rim;
a fluid-tight, annular apron extending from the outer periphery of the second rim and surrounding a disc-shaped second recess; wherein the diameter of the second recess is dimensioned to correspond to the diameter of the first ring of the connector to provide a fluid-tight interlocking connection when the connector and the closure are pushed together along the central axis.

The connector kit according to this aspect enables a mechanically simple interlocking connection between a beverage dispensing line and a beverage container which can be engaged automatically by using the same pressure source from a beverage dispensing device that is used for collapsing the beverage container and thus not requiring any additional steps of intervention from the user.

The interlocking connection established between the first ring of the connector and the annular apron extending from the outer periphery of the second rim and surrounding a disc-shaped second recess in the closure is strong enough to keep the dispensing line attached to the closure while the beverage container is being pulled, but not too strong so that the dispensing line can still be removed manually from the closure without the need of additional tools.

This allows easy and effective installation, as well as removal of both the beverage dispensing line and the beverage container from a beverage dispensing device, thereby reducing the risk of bacterial growth or clogging in the beverage dispensing system, resulting in a longer life of keg in system than the normal 5-7 days.

The arrangement of the connector and closure also enables a fluid-tight connection with less materials, since no separate gasket is needed between connector and the closure of the beverage container.

The option that the dispensing line can be manufactured and shipped separately adds the flexibility to use one dispensing line and connector with different beverage container that use similar types of closures.

In a possible implementation form of the third aspect the interlocking connection is an annular snap-fit connection provided through a corresponding protrusion and recess arranged in engaging surfaces of the first ring and the apron and configured to counter a pulling force applied between the connector and the closure to a predefined extent.

In another possible implementation form of the third aspect the interlocking connection is an annular press-fit or interference fit connection provided through friction between engaging surfaces of the first ring and the apron and configured to counter a pulling force applied between the connector and the closure to a predefined extent.

In a possible implementation form of the third aspect the apron is arranged to extend from the second rim in an at least partially outwardly tapered shape, to provide a guiding surface for the first ring.

In a possible implementation form of the third aspect the apron comprises a base portion extending directly from the second rim in an inwardly tapered shape for providing additional friction between the first ring and the apron.

According to a fourth aspect, there is provided a system for dispensing beverage comprising:
beverage dispensing line comprising a dispensing line valve arranged at one distal end and a connector according to any one of claims 1 to 15 arranged at another distal end;
a beverage container comprising a closure, the closure Comprising means to provide a fluid-tight interlocking connection with the connector when the connector and the closure are pushed together along a central axis;
a beverage dispensing device comprising a receptacle for receiving and accommodating the beverage container therein, the receptacle comprising a cavity for receiving the closure of the beverage container when the beverage container is received in the receptacle,
the cavity comprising a seat with a through-hole dimensioned for allowing the dispensing line with the dispensing line valve arranged at its one distal end to be pulled through the through-hole, and
the seat being dimensioned to abut the flange of the connector when the line connector end is received in the through-hole.

The system according to this aspect enables a mechanically simple interlocking connection between a beverage dispensing line and a beverage container which can be engaged automatically by inserting the beverage container in the beverage dispensing device and using the same pressure source that is used for collapsing the beverage container, thus not requiring any additional steps of intervention from the user for establishing the connection. The connection achieved through the connector being abutted on the seat of the cavity and pushed to the closure is strong enough to keep the dispensing line attached to the closure of the beverage container while removing from a beverage dispensing device, but not too strong so that it can still be removed from the beverage container manually without the need of additional tools.

This allows easy and effective installation, as well as removal of both the beverage dispensing line and the beverage container from a beverage dispensing device, thereby reducing the risk of bacterial growth or clogging in the beverage dispensing system, resulting in a longer life of keg in system than the normal 5-7 days.

The option that the dispensing line can be manufactured and shipped separately adds the flexibility to use one dispensing line and connector with different beverage container that use similar types of closures.

According to a fifth aspect, there is provided a method comprising:
providing a beverage dispensing device comprising a receptacle for receiving and accommodating a beverage container therein, the receptacle comprising a cavity for receiving a closure of the beverage container, the cavity comprising a seat with a through-hole;
providing a beverage dispensing line with a dispensing line valve arranged at one distal end and a connector according to any one of claims 1 to 15 arranged at another distal end;
arranging the beverage dispensing line in the beverage dispensing device by pulling first the dispensing line valve and then the beverage dispensing line through the through-hole, until the flange abuts the seat of the connector;
providing a beverage container comprising a closure, the closure comprising means to provide a fluid-tight interlocking connection with the connector;
placing the beverage container in the receptacle so that the closure is arranged in the cavity; and
applying pressure on the beverage container so that the connector and the closure are pushed together into an interlocking connection.

The method according to this aspect enables a mechanically simple interlocking connection between a beverage dispensing line and a beverage container which can be engaged automatically by using the same pressure source from a beverage dispensing device that is used for collapsing the beverage container and thus not requiring any additional steps of intervention from the user. The established connection is strong enough to keep the dispensing line attached to the closure of the beverage container while removing from beverage dispensing device, but not too strong so that it can still be removed from the beverage container manually without the need of additional tools. This allows easy and effective installation, as well as removal of both the beverage dispensing line and the beverage container from a beverage dispensing device, thereby reducing the risk of bacterial growth or clogging in the beverage dispensing system, resulting in a longer life of keg in system than the normal 5-7 days.

In a possible implementation form of the fifth aspect the method further comprises removing the beverage container from the receptacle, the removing comprising pulling the entire beverage dispensing line through the through-hole while maintaining the interlocking connection between the connector of the beverage dispensing line and the closure of the beverage container.

In a possible implementation form of the fifth aspect the method further comprises manually separating the beverage dispensing line from the removed beverage container by pulling apart the connector from the closure along the central axis.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a cross-section of a connector in accordance with an embodiment of the disclosure;

FIGS. 2A and 2B show elevated and lowered perspective views of a connector in accordance with an embodiment of the disclosure;

FIGS. 3A and 3B show a 90-degrees turned side view and corresponding cross-section of a connector in accordance with an embodiment of the disclosure;

FIG. 4 shows a top view of a connector in accordance with an embodiment of the disclosure;

FIG. 5 shows a bottom view of a connector in accordance with an embodiment of the disclosure;

FIG. 6 shows a cross-section of a dispensing line in accordance with an embodiment of the disclosure;

FIG. 7 illustrates a dispensing line in an assembled state in accordance with an embodiment of the disclosure;

FIG. 8 shows a side view of a closure of a connector kit in a disassembled state in accordance with an embodiment of the disclosure;

FIG. 9 shows a cross-section of a closure of a connector kit in an assembled and ready-to-be shipped state in accordance with an embodiment of the disclosure;

FIG. 10 shows a close-up cross-section of a closure of a connector kit in accordance with an embodiment of the disclosure;

FIG. 11 shows a close-up cross-section of a connector kit in a connected state in accordance with an embodiment of the disclosure;

FIG. 12 shows a close-up cross-section of a connector kit in a connected state in accordance with another alternative embodiment of the disclosure;

FIG. 13 shows a cross-section of a system for dispensing beverage in accordance with an embodiment of the disclosure; and

FIG. 14A through 14F illustrate steps of a method for installing a beverage container in a system for dispensing beverage in accordance with an embodiment of the disclosure.

### DETAILED DESCRIPTION

In the illustrated embodiments described below, structures and features that are the same or similar to corresponding structures and features previously described are denoted by the same reference numeral as previously used for simplicity.

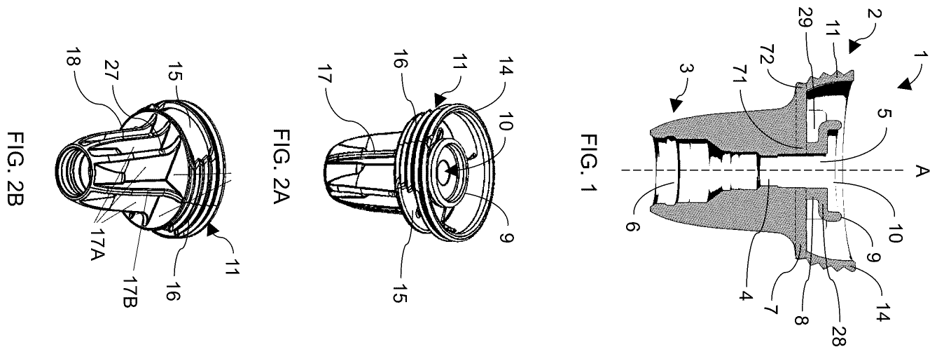

FIG. 1 shows a cross-section of a connector 1 for connecting a beverage dispensing line 19 to a beverage container 40 in accordance with an embodiment of the disclosure.

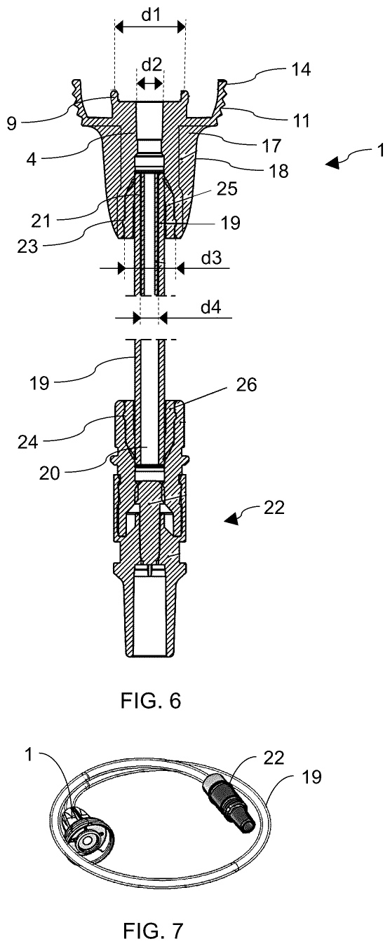

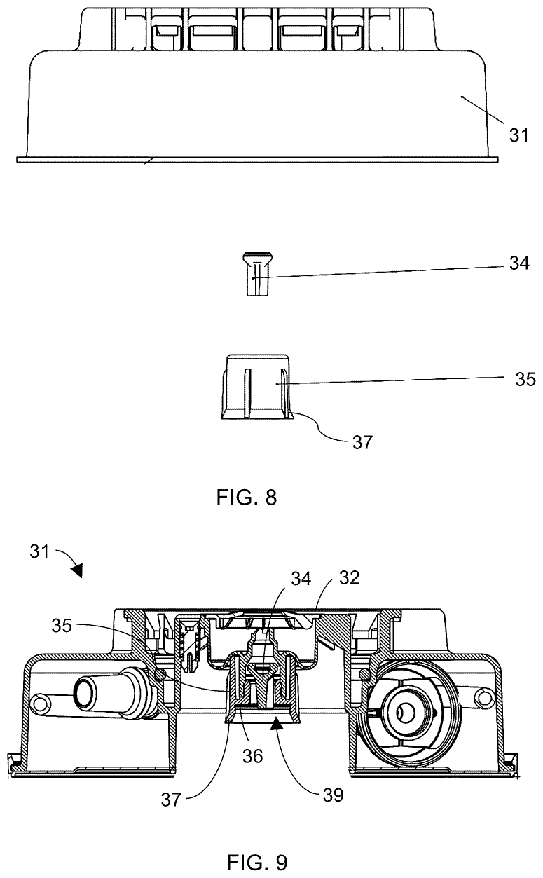

The connector 1 comprises a keg connector end 2 for connecting to a closure 31 of a beverage container 40, such as the one shown in FIGS. 8 and 9; and a line connector end 3 for connecting to a beverage dispensing line 19 as shown in FIGS. 6 and 7.

A central passageway 4 extends along a central axis A of the connector 1 between the keg connector end 2 and the line connector end 3.

The keg connector end 2 comprises a flange 7 with a central portion 71 surrounding the central passageway and a peripheral portion 72 surrounding the central portion 71.

A fluid-tight, annular first wall 8 extends from the central portion 71 of the flange 7 and surrounds a first distal end 5 of the central passageway 4.

A fluid-tight, annular first ring 9 extends from this first wall 8 and surrounds a disc-shaped first recess 10.

The first wall 8 may comprise a first wall flange 28 arranged at its distal end from the flange 7, as shown in FIG. 1, the first wall flange 28 having a larger outer diameter than the first wall 8 itself, and the first ring 9 can extend from the periphery of the first wall flange 28.

In this embodiment support walls 29 may be further arranged extending from the first wall 8 between the flange 7 and the first wall flange 28 for structural support of the first ring 9 and the first wall flange 28 when engaging with a surface of a closure 31 of a beverage container 40.

The keg connector end 2 further comprises an annular skirt 11 extending from the peripheral portion 72 of the flange 7 and surrounding the first wall 8 and the first ring 9. The skirt 11 comprises a second ring 14 arranged at a distal end opposite from the flange 7.

In the illustrated embodiment, the skirt 11 extends further from the flange 7 than the first wall 8 and the first ring 9 to protect the first ring 9, and the diameter of the second ring 14 is larger than the diameter of the flange 7.

The connector 1 according to the illustrated embodiment is a solid, single-piece item, preferably from plastic, more preferably recyclable polypropylene such as PP RJ377 MO.

In an embodiment the connector 1 is mass manufactured via injection molding.

FIGS. 2A and 2B show elevated and lowered perspective views respectively of a connector in accordance with an embodiment of the disclosure. As shown in these figures, the skirt 11 comprises at least one cut-out segment 15, and at least one solid segment 16 arranged intermittently with said at least one cut-out segment 15 to connect the flange 7 with the second ring 14 arranged at a distal end of the skirt 11 opposite from the flange 7.

As shown in FIGS. 2A and 2B, as well as FIG. 5, the connector 1 further comprises ribs 17 extending radially from the outer wall of the line connector end 3, the at least one rib 17 comprising an outer rib surface 18 facing radially outwards from the line connector end 3 for engaging with a corresponding support surface of a beverage dispensing device 41.

As shown in FIG. 2B, the ribs 17 in the illustrated embodiment extend from the line connector end 3 to the flange 7 in an outwardly tapered shape towards the flange 7.

At least one rib 17 further comprises snap-lock means 27 arranged on the outer rib surface 18 for enabling a snap-lock interlocking engagement with a corresponding support surface of a beverage dispensing device 41 when the connector is placed in a seat 44 thereof (as described later).

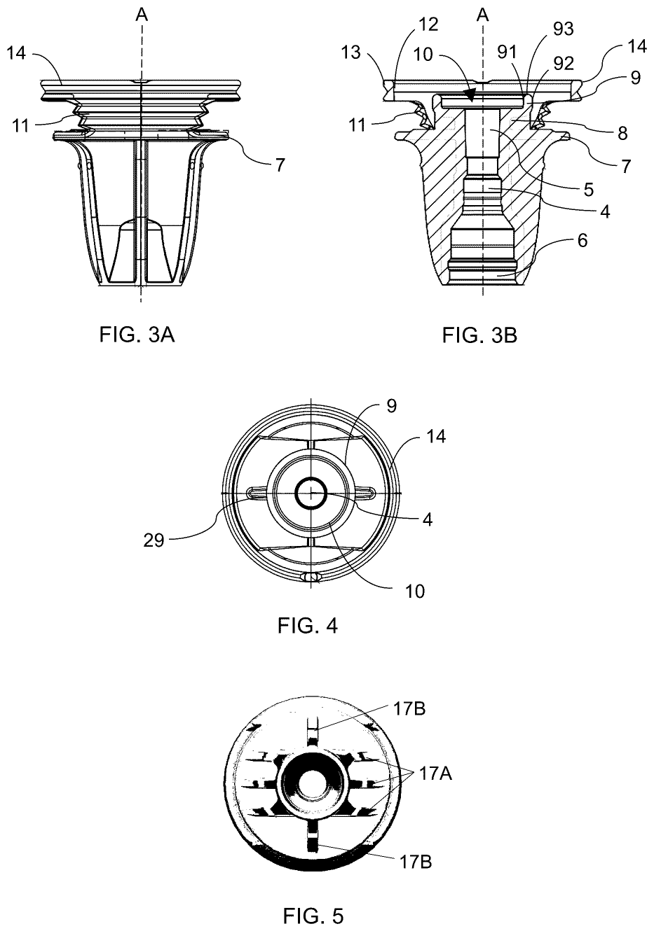

FIGS. 3A and 3B show a 90-degrees turned side view and corresponding cross-section of a connector in accordance with an embodiment of the disclosure.

As shown in FIG. 3B, the first ring 9 extends from the first wall 8 and can define an inner ring wall 91 towards the first recess 10 and an opposite outer ring wall 92.

The inner ring wall 91 may extend in parallel with the outer ring wall 92, and the inner ring wall 91 and the outer ring wall 92 may extend also in parallel with the central axis A. The first ring 9 comprises a polished, rounded first rim 93 for better engaging with a surface of a closure 31 of a beverage container 40.

As also shown in FIG. 3B, the skirt 11 may extend from the flange 7 to define an inner skirt wall 12 towards the first wall 8, and an opposite outer skirt wall 13.

As shown in FIG. 3A, and FIGS. 2A and 2B, at least the outer skirt wall 13 may comprise a corrugated surface for enhanced structural integrity and for providing a better gripping surface for grabbing the skirt 11 when attaching or removing the connector from a closure 31.

FIG. 4 shows a top view of a connector in accordance with an embodiment of the disclosure. As shown in this embodiment, a plurality of support walls 29 extends radially from the first wall 8 below the first ring 9, in particular four support walls 29 are arranged at angles of 90° extending radially from the first wall 8.

FIG. 5 shows a bottom view of a connector in accordance with an embodiment of the disclosure. In this illustrated embodiment the connector 1 comprises a plurality of ribs 17 extending from the outer wall, with a first group of ribs 17A extending in parallel to each other, and in parallel with a mold separation direction of the connector 1. A further second pair of ribs 17B extends perpendicular to the mold separation direction of the connector 1.

FIG. 6 shows a cross-section of a dispensing line 19 in accordance with an embodiment of the disclosure.

The beverage dispensing line 19 comprises a valve line end 20 with a dispensing line valve 22 arranged thereon for selectively allowing or blocking flow of beverage through the dispensing line 19; and a connector line end 21 comprising a connector 1 for connecting the beverage dispensing line 19 to a beverage container 40 as described above and shown through FIGS. 1 to 5. The connector 1 is connected to the connector line end 21 via a first line adapter 25 arranged around the connector line end 21 and shaped to snap-fit into a correspondingly shaped first adapter recess 23 arranged at the line connector end 3 of the connector.

The first recess 10 of the connector 1 is arranged with a first diameter d1, and the central passageway 4 of the connector 1 is arranged with a second diameter d2, wherein the first diameter is larger than the second diameter d1>d2 to create a fluid-tight enlarged space when connecting to a closure 31 of a beverage container 40.

A second distal end 6 of the central passageway 4 at the line connector end 3 is arranged with a third diameter d3 that is larger than a second diameter d2 of the rest of the central passageway 4, d3>d2, thereby defining a first adapter recess 23 shaped to receive a first line adapter 25 arranged around a distal end of a beverage dispensing line 19.

In an embodiment the third diameter d3 of the first adapter recess 23 is smaller than the first diameter d1 of the first recess 10, i.e. d3<d1.

The beverage dispensing line 19 is arranged with a fourth diameter d4. In an embodiment the fourth diameter substantially corresponds to the second diameter d4=d2.

The dispensing line valve 22 is connected to the valve line end 20 of the beverage dispensing line 19 via a second line adapter 26 arranged around the valve line end 20 and shaped to snap-fit into a correspondingly shaped second adapter recess 24 arranged in the dispensing line valve 22.

In an embodiment the first line adapter 25 and the second line adapter 26 are identical and interchangeable.

The beverage dispensing line 19 is made from any flexible plastic material suitable for use in beverage dispense systems, preferably made from recyclable plastic.

FIG. 7 illustrates a dispensing line 19 in an assembled state in accordance with an embodiment of the disclosure, with a dispensing line valve 22 arranged thereon for selectively allowing or blocking flow of beverage through the dispensing line 19 and a connector 1 arranged at the connector line end 21 for connecting the beverage dispensing line 19 to a closure 31 of a beverage container 40, as shown below in FIG. 11. The dispensing line 19 is designed to be shipped in this assembled state, for example by placing into the closure 31 of a beverage container 40 as shown in FIG. 9.

FIG. 8 shows a side view of a closure 31 of a connector kit for connecting a beverage dispensing line 19 to a beverage container 40 in accordance with an embodiment of the disclosure.

The closure 31 comprises a beverage valve 34 for selectively allowing or blocking flow of beverage from the beverage outlet through the closure 31, and an annular second wall 35 surrounding the beverage valve 34, with a fluid-tight, annular apron 37 extending therefrom.

FIG. 9 shows a cross-section of a closure 31 of a connector kit as described above, in an assembled and ready-to-be shipped state, in accordance with an embodiment of the disclosure.

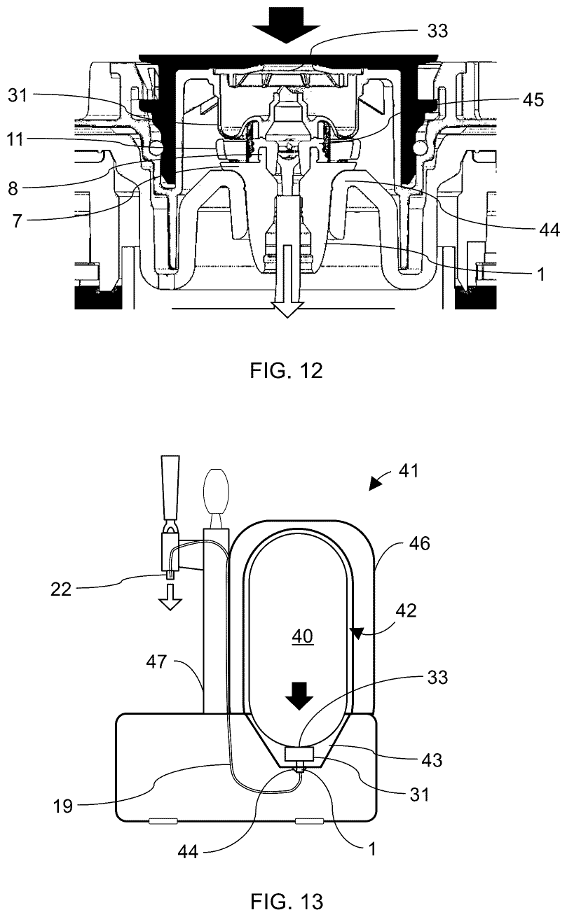

The closure 31 comprises coupling means 32 for firmly and sealingly connecting the closure 31 to a beverage container 40 at a beverage outlet opening 33 thereof as shown in FIGS. 12 and 13; a beverage valve 34 as mentioned above; and annular second wall 35 surrounding the beverage valve 34 and comprising a second rim 36.

A fluid-tight, annular apron 37 extends from the outer periphery of the second rim 36 and surrounds a disc-shaped second recess 39.

The diameter of the second recess 39 is dimensioned to correspond to the diameter of the first ring 9 of the connector to provide a fluid-tight interlocking connection when the connector and the closure 31 are pushed together along the central axis A as shown below in FIG. 11.

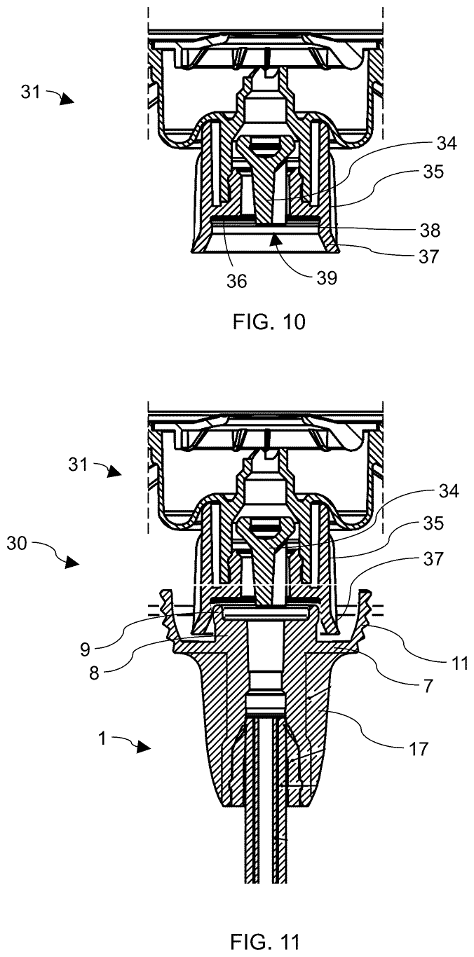

FIG. 10 shows a close-up cross-section of a closure 31 of a connector kit in accordance with an embodiment of the disclosure. As shown in this embodiment, the apron 37 is arranged to extend from the second rim 36 in an at least partially outwardly tapered shape, to provide a guiding surface for the first ring 9, as shown below in FIG. 11. In the illustrated embodiment, the apron 37 comprises a base portion 38 extending directly from the second rim 36 in an inwardly tapered shape for providing additional friction between the first ring 9 and the apron 37.

FIG. 11 shows a close-up cross-section of a connector kit in a connected state in accordance with an embodiment of the disclosure, comprising a connector 1 as described before with respect to FIGS. 1 to 5, and a closure as described before with respect to FIGS. 8 to 10. As shown, the interlocking connection between the connector 1 and the closure is an annular press-fit or interference fit connection provided through friction between engaging surfaces of the first ring 9 and second rim 36 and the apron 37, the amount of friction resulting from the engaging surfaces configured to counter a pulling force applied between the connector 1 and the closure 31 to a predefined extent, so that when the closure 31 is lifted together with the beverage container 40 during removal from the beverage dispensing device 41, the connection remains and results in pulling the entire dispensing line 19 together with the beverage container 40, for simultaneous replacement without any additional action needed from the user of the device 41.

In an alternative embodiment (not shown) the interlocking connection is an annular snap-fit connection provided through a corresponding protrusion and recess arranged in engaging surfaces of the first ring 9 and the apron 37 and configured to counter a pulling force applied between the connector 1 and the closure 31 to a similar predefined extent as explained above.

Once removed from the beverage dispensing device 41, the user can grab the protective skirt 11 and detach the dispensing line 19 from the closure 31 of the beverage container 40 without touching the inner portions of the connector, such as the first wall 8 or the first ring 9.

FIG. 12 shows a close-up cross-section of a connector kit in a connected state in accordance with another alternative embodiment of the disclosure. In this alternative embodiment the connector 1 comprises at least one annular gasket 45 arranged on or around the flange 7, the first wall 8 and/or the first ring 9, for providing additional sealing for a fluid-tight connection between the connector 1 and the closure 31 of a beverage container.

As shown in FIG. 12, the seat 44 of the cavity 43 in the beverage dispensing device 41 is shaped as an annular funnel for providing a corresponding surface to the line connector end 3 of the connector, in particular for fittingly engaging with the outer rib surfaces 18 of the ribs 17 extending radially from the outer wall of the line connector end 3. The seat 44 thus provides a firm support for the connector 1 when the closure 31 is pressed against the connector 1, resulting in the interlocking connection as described above.

FIG. 13 shows a cross-section of a system for dispensing a beverage according to an embodiment of the present disclosure. The beverage may be for example beer, a carbonated malt-based beverage, including non-alcoholic beer, or cider.

A tapping head for dispensing beverage is supported on a beverage font 47 or may be arranged directly on a body of a beverage dispensing system (not shown) that can hold a beverage container. The tapping head is provided with a tap handle configured to be operatively connected to the exchangeable dispensing line valve 22 inserted therein, for controlling of the opening and closing of the dispensing line valve 22, and thus ultimately for controlling the flow of beverage from the dispensing line 19 through the tapping head. The tapping head may further be provided with a tapping display arranged on top for displaying information about the beverage on tap at the respective tapping head.

The system comprises an (exchangeable) beverage container 40 for accommodating a beverage, the beverage container 40 comprising a beverage outlet 33 fitted with a closure 31. The beverage container 40 may be recyclable or disposable after exchanging from an empty to a new beverage container 40. The beverage dispensing line 19 extends from the connector 1 arranged in the seat 44 of the cavity 43 through a channel arranged in the beverage dispensing device 41 and along the rear side of the beverage font 47, to the tapping head.

The beverage dispensing device 41 further has a drain hole (not shown) leading from the lowest point of the channel to an opening at the bottom of the device 41 to drain residual beer from the channel after removal of the dispensing line 19.

The body of the beverage dispensing device 41 comprises a cavity 43, and a receptacle 42 arranged in a lid 46, together configured for receiving a beverage container 40. The cavity 43 is designed and shaped for receiving at least a portion of the beverage container 40, preferably a smaller portion of the beverage container 40 comprising the closure 31 in an upside-down position; and the lid 46 is arranged to cover at least a portion, preferably a larger portion of the beverage container 40 when the at least one beverage container 40 is installed in the beverage dispensing device 41.

The cavity 43 is arranged at the bottom of the beverage dispensing device 41 below the receptacle 42. The cavity 43 comprises a seat 44 with a through-hole and adapted for receiving at least one type of closure 31 of an exchangeable beverage container 40 and for allowing passage of the exchangeable dispensing line 19, as will be explained below. The seat 44 may be interchangeable in order to adapt the beverage dispensing system to an exchangeable dispensing line 19 or a fixed dispensing line, respectively.

The closure 31 of suitable beverage container 40 is insertable into the keg closure cavity 43 and may be fixated to the seat 44 in a sealed and pressure-tight fit. Preferably, the closure 31 is fixated to the seat 44 e.g. by a screw fit, bayonet fit or the like.

The beverage containers 40 used for the system may be blow moulded and of adapted in shape and volume to the volume of the pressure chamber realized by the receptacle 42 and the cavity 43. This allows for mass production of both the beverage containers and the beverage dispensing systems. The pressure housing of the beverage dispensing system and the corresponding beverage containers may be provided in different sizes.

The closure 31 may seal against the pressure chamber and may provide a flange onto which the beverage container 40 may rest and which may also be used for carrying the beverage container 40. The mouthpart of the beverage container 40, onto which the closure 31 is fixed in a fluid-tight, stable and permanent connection, is typically the same of all sizes of kegs and thus, the sole difference between the variants of the closures 33 may be whether an integrated dispensing line, a connectable dispensing line, or an openable seal is used. Thus, identical standardized closures 33 may be produced having a mouthpart, which may connect to standardized neck parts of beverage containers 40 that may have different sizes. The seat 44 may be installed permanently in the keg closure cavity 43, such that the beverage dispensing system is permanently made to be used with the specific keg type. Alternatively, the user may be provided with different types of seats 44 allowing the user to change seat type on site in order to be able to modify the beverage dispensing system to be used with different keg types according to consumption of a particular beverage.

A pressure inlet may be adapted for receiving a pressure medium and transport the pressure medium to an interspace between the outer wall of the beverage container 40 and the inner wall of the lid 46. The interspace is typically made as small as possible, e.g. a few millimeters of width, in order to allow a tight fit between a beverage container 40 and a pressure chamber. The pressure inlet may form part of e.g. the receptacle 42, the lid 46 or the seat 44, and may optionally include a one-way valve and/or overpressure valve. The pressure medium is typically air; however, any fluid would be feasible, such as CO2, N2, water etc.

The beverage dispensing system may comprise a compressor and/or a gas cylinder selectively connectable to the pressure inlet for providing the pressure medium to the interspace. In order to make the system more modular, the pressure inlet and the beverage dispensing systems may be compatible with different pressurization units. A compressor may be used when access to either mains power or battery power is available to power the compressor allowing it to pressurize the pressure chamber by taking atmospheric air from the outside, pressurize it and inject the pressurized air into the interspace of the pressure chamber. A gas cylinder may be used where no mains power is available and/or batteries are considered an inconvenient choice. The gas cylinder is pre-loaded with a pressurized gas, e.g. air, nitrogen, carbon dioxide or the like.

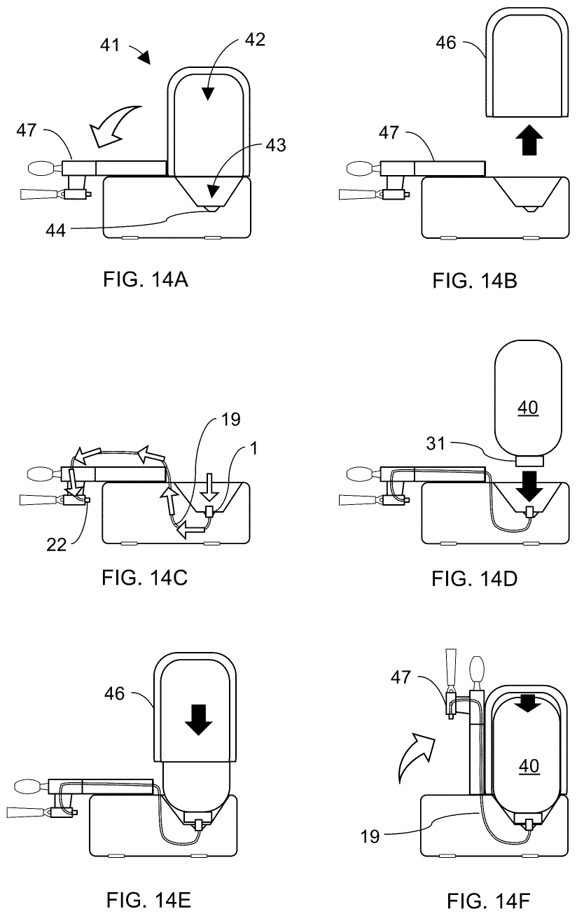

The separation of the lid 46 from the body of the beverage dispensing device 41 may be dependent on tilting the beverage font 47 forward towards its front side, as shown in FIG. 14A, to release locking means keeping the body and the lid 46 joined together in a pressure resistant connection. The tilting of the beverage font 47 may be further dependent on engaging pressure release means, such as a pressure release button arranged on the front side of the beverage font 47, which triggers pressure release in the pressure chamber, thereby allowing separation of the lid 46 from the body by equalizing pressure within the pressure-tight sealable enclosure formed by the body and the lid 46.

In some embodiments, the body and the lid 46 are only partially separable such that the lid 46 remains connected to the body, e.g. through a hinge. The sealable enclosure may define a volume between 2 and 100 litres, preferably between 5 and 50 litres, more preferably between 10 and 25 litres. The above volumes constitute typical volumes of a pressure chamber. The beverage containers have a corresponding size, being slightly smaller for a tight fit inside the pressure chamber.

According to a further embodiment, the beverage dispensing system may comprise additional housing parts acting as a replacement of the lid 46, having an additional volume and being connectable to the base of the beverage dispensing device 41 for establishing a sealable enclosure serving as pressure chamber. In this way, the same base body may be used together with different further housing parts of different size so that the beverage dispensing system may be modified to a specific beverage container size, e.g. 5 liters, 10 liters or 20 liters. The additional housing parts may be exchangeable by the user, e.g. by providing a screw mount. The pressure chamber created by the receptacle 42 may be thermally insulated. The thermal insulation may be used in conjunction with a cooling device for cooling of the at least one keg 40 and any beverage accommodated therein, or alternatively, the cooling device may be dispensed with and instead a thermal insulation is used in conjunction with pre-chilled beverage containers in order to save weight in e.g. carry-on appliances.

The beverage dispensing system may further comprise a first electric power unit including a mains supply and a second power unit including a battery supply, and, optionally, a third power supply including a solar power supply. In order to further enhance the modularity of the system, it may be compatible with different power supplies. For fixed indoor installations, a mains power supply, e.g. 115V or 230V AC household supply, is preferred since it offers essentially unlimited power to the system for powering both cooling and pressurization units as well as other features such as lighting etc. Batteries may advantageously be used in mobile appliances. The batteries may e.g. be rechargeable by the use of a mains supply and a power converter. Solar power may be used for directly powering the beverage dispensing system, however, due to the limited output of solar cells when no direct sunlight is available it is mostly considered an auxiliary power unit to be used in conjunction with rechargeable batteries.

FIG. 14A through 14F illustrate steps of a method for installing a beverage container in a system for dispensing beverage in accordance with an embodiment of the disclosure. The embodiment shown in FIGS. 14A-14F may correspond to the embodiment of FIG. 13.

As shown in FIG. 14A, the beverage font 47 is movable from an upright operative position to a tilted service position, preferably by tilting the beverage font 47 towards the front side, e.g. around a hinge arranged at the base thereof. This tilting is preferably possible to a degree between 0-90 degrees around the hinge from vertical, more preferably to at least 45 degrees from vertical. The rear side of the beverage font 47 that is obscured in the operative position shown in FIG. 14F thus becomes exposed in the service position shown in FIGS. 14A-14E, for making it possible to insert or remove the beverage container 40 and the beverage dispensing line 19, as will be explained in more detail below.

As shown in FIG. 14A, when the beverage font 47 is tilted 90 degrees to the front it may rest at a base portion of the beverage dispensing system. The contact surface between the beverage font assembly 1 and the base portion may be a surface comprising a drip tray adapted to place beverage glasses on for receiving the beverage from the tapping head.

As shown in FIG. 14B, when the beverage font 47 is tilted forwards, a portion of the body of the beverage dispensing system defined as the lid 46 may be separated at least partially from a lower portion of the body comprising the cavity 43, thereby allowing an exchangeable beverage container 40 and beverage dispensing line 19 to be inserted or removed and replaced, as will be explained in more detail below.

As shown in FIG. 14C, after removing the lid 46 in the service position, the beverage dispensing line 19 comprising a dispensing line valve 22 arranged at one distal end and a connector 1 arranged at another distal end can be inserted into the cavity 43. In particular, the beverage dispensing line 19 is inserted in the beverage dispensing device 41 by pulling first the dispensing line valve 22 and then the beverage dispensing line 19 through the through-hole of the seat 44 arranged at the bottom of the cavity 43 and through a channel arranged in the body of the beverage dispensing device 41, ending at the base of the font 47, until the flange 7 of the connector 1 abuts the seat 44. Once the connector 1 is in place at the seat 44, the dispensing line valve 22 can be inserted in the tapping head (using e.g. an applicator), and the rest of the dispensing line 19 can be inserted into a channel or recess arranged at the back of the font 47.

As shown in FIG. 14D, once the dispensing line 19 is fully arranged in place in the body and font 47 of the beverage dispensing device 41, a beverage container 40 comprising a closure 31 compatible with the connector 1 and the seat 44 can be placed so that the closure 31 is received in the cavity 43 and is aligned with the connector 1 placed on the seat 44. As shown in FIG. 14E, after the beverage container 40 is in place, the lid 46 can be slid back into position on the body of the beverage dispensing device 41 and locked. When these two parts are connected together, using a pressure-resistant connection, preferably a bayonet mount, a pressure-tight sealable enclosure serving as pressure chamber is established. The housing of the body is preferably made of pressure proof materials, such as metal or rigid plastic, so that a pressure chamber can be established within.

As shown in FIG. 14F, once the lid 46 is in place, the font 47 can be tilted back to operative position, and pressure can be applied from a pressure source on the beverage container 40 so that the connector 1 and the closure 31 are pushed together into a fluid-tight interlocking connection, and further that beverage can be dispensed from the container 40 once the valve 22 is open.

For removing or replacing the beverage container 40, the steps need to be reversed in the order from FIG. 14F to FIG. 14A.

When removing the beverage container 40 from the cavity 43 corresponding to steps 14D and 14C, the entire beverage dispensing line 19 together with the dispensing line valve 22 is pulled through the through-hole while maintaining the interlocking connection between the connector 1 of the beverage dispensing line 19 and the closure 31 of the beverage container 40.

The beverage dispensing line 19 can then be manually separated from the removed beverage container 40 by pulling apart the connector 1 from the closure 31 along the central axis A.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. A connector for connecting a beverage dispensing line to a beverage container, the connector comprising:
a keg connector end for connecting to a closure of a beverage container a line connector end for connecting to a beverage dispensing line;
a central passageway extending along a central axis of the connector between the keg connector end and the line connector end; wherein
the keg connector end comprises
a flange comprising a central portion surrounding the central passageway and a peripheral portion surrounding the central portion;
a fluid-tight, annular first wall extending from the central portion of the flange and surrounding a first distal end of the central passageway; and
a fluid-tight, annular first ring extending from the first wall and surrounding a disc-shaped first recess.

2. The connector according to claim 1, wherein the keg connector end further comprises an annular skirt extending from the peripheral portion of the flange and surrounding the first wall and the first ring.

3. The connector according to claim 2, wherein the skirt extends further from the flange than the first wall and the first ring.

4. The connector according to claim 2, wherein the skirt extends from the flange to define an inner skirt wall towards the first wall, and an opposite outer skirt wall, wherein at least the outer skirt wall comprises a corrugated surface.

5. The connector according to claim 2, wherein the skirt comprises a second ring arranged at a distal end opposite from the flange, the diameter of the second ring being larger than the diameter of the flange.

6. The connector according to claim 2, wherein the skirt comprises at least one cut-out segment, and at least one solid segment arranged intermittently with said at least one cut-out segment to connect the flange with a second ring arranged at a distal end of the skirt opposite from the flange.

7. The connector according to claim 1, wherein the first wall comprises a first wall flange arranged at its distal end from the flange, the first wall flange having a larger outer diameter than the first wall, and wherein the first ring extends from the periphery of the first wall flange.

8. The connector according to claim 7, wherein the connector comprises at least one support wall extending from the first wall between the flange and the first wall flange for structural support of the first ring and the first wall flange when engaging with a surface of a closure of a beverage container.

9. The connector according to claim 1, wherein the first ring extends from the first wall to define an inner ring wall towards the first recess, and an opposite outer ring wall, the inner ring wall extending in parallel with the outer ring wall.

10. The connector according to claim 1, wherein the first ring comprises a rounded first rim for engaging with a surface of a closure of a beverage container.

11. The connector according to claim 1, wherein the connector further comprises at least one rib extending radially from the outer wall of the line connector end, the at least one rib comprising an outer rib surface facing radially outwards from the line connector end for engaging with a corresponding support surface of a beverage dispensing device.

12. The connector according to claim 11, wherein the at least one rib comprises snap-lock means arranged on the outer rib surface for enabling a snap-lock interlocking engagement with a corresponding support surface of a beverage dispensing device.

13. The connector according to claim 1, wherein the first recess is arranged with a first diameter d1, the central passageway is arranged with a second diameter d2, and wherein the first diameter is larger than the second diameter d1>d2.

14. The connector according to claim 1, wherein a second distal end of the central passageway at the line connector end is arranged with a third diameter d3 that is larger than a second diameter d2 of the rest of the central passageway d3>d2, thereby defining a first adapter recess shaped to receive a first line adapter arranged around a distal end of a beverage dispensing line of a fourth diameter d4, the fourth diameter substantially corresponding to the second diameter d4=d2.

15. The connector according to claim 1, wherein the connector is a solid, single-piece item, preferably from plastic, more preferably recyclable polypropylene such as PP RJ377 MO.

16. A beverage dispensing line for a beverage container, the beverage dispensing line comprising:
a valve line end comprising a dispensing line valve for selectively allowing or blocking flow of beverage through the dispensing line; and
a connector line end comprising a connector according to claim 1 for connecting the beverage dispensing line to a beverage container.

17. The beverage dispensing line according to claim 16, wherein the dispensing line valve is connected to the valve line end via a second line adapter arranged around the valve line end and shaped to snap-fit into a correspondingly shaped second adapter recess arranged in the dispensing line valve.

18. The beverage dispensing line according to claim 16, wherein the connector line end comprises a connector according to claim 12, the connector being connected to the connector line end via the first line adapter arranged around the connector line end and shaped to snap-fit into the correspondingly shaped first adapter recess arranged at the line connector end of the connector.

19. A connector kit for connecting a beverage dispensing line to a beverage container, the kit comprising:
a connector according to claim 1; and
a closure for a beverage container, the closure comprising:
coupling means for firmly and sealingly connecting the closure to a beverage container at a beverage outlet opening thereof;
a beverage valve for selectively allowing or blocking flow of beverage from the beverage outlet through the closure;
a fluid-tight, annular second wall surrounding the beverage valve and comprising a second rim;
a fluid-tight, annular apron extending from the outer periphery of the second rim and surrounding a disc-shaped second recess; wherein the diameter of the second recess is dimensioned to correspond to the diameter of the first ring of the connector to provide a fluid-tight interlocking connection when the connector and the closure are pushed together along the central axis.

20. The connector kit according to claim 19, wherein the interlocking connection is an annular snap-fit connection provided through a corresponding protrusion and recess arranged in engaging surfaces of the first ring and the apron and configured to counter a pulling force applied between the connector and the closure to a predefined extent.

21. The connector kit according to claim 19, wherein the interlocking connection is an annular press-fit or interference fit connection provided through friction between engaging surfaces of the first ring and the apron and configured to counter a pulling force applied between the connector and the closure to a predefined extent.

22. The connector kit according to claim 19, wherein the apron is arranged to extend from the second rim in an at least partially outwardly tapered shape, to provide a guiding surface for the first ring.

23. The connector kit according to claim 19, wherein the apron comprises a base portion extending directly from the second rim in an inwardly tapered shape for providing additional friction between the first ring and the apron.

24. A system for dispensing beverage comprising:
beverage dispensing line comprising a dispensing line valve arranged at one distal end and a connector according to claim 1 arranged at another distal end;
a beverage container comprising a closure the closure comprising means to provide a fluid-tight interlocking connection with the connector when the connector and the closure are pushed together along a central axis;
a beverage dispensing device comprising a receptacle for receiving and accommodating the beverage container therein,
the receptacle comprising a cavity for receiving the closure of the beverage container when the beverage container is received in the receptacle,
the cavity comprising a seat with a through-hole dimensioned for allowing the dispensing line with the dispensing line valve arranged at its one distal end to be pulled through the through-hole, and
the seat being dimensioned to abut the flange of the connector when the line connector end is received in the through-hole.

25. A method comprising:
providing a beverage dispensing device comprising a receptacle for receiving and accommodating a beverage container therein, the receptacle comprising a cavity for receiving a closure of the beverage container, the cavity comprising a seat with a through-hole;
providing a beverage dispensing line with a dispensing line valve arranged at one distal end and a connector according to claim 1 arranged at another distal end;
arranging the beverage dispensing line in the beverage dispensing device by pulling first the dispensing line valve and then the beverage dispensing line through the through-hole, until the flange of the connector abuts the seat;
providing a beverage container comprising a closure the closure comprising means to provide a fluid-tight interlocking connection with the connector;
placing the beverage container in the receptacle so that the closure is arranged in the cavity; and
applying pressure on the beverage container so that the connector and the closure are pushed together into an interlocking connection.

26. The method according to claim 25 further comprising:
removing the beverage container from the receptacle the removing comprising pulling the entire beverage dispensing line through the through-hole while maintaining the interlocking connection between the connector of the beverage dispensing line and the closure of the beverage container.

27. The method according to claim 26 further comprising:
manually separating the beverage dispensing line from the removed beverage container by pulling apart the connector from the closure along the central axis.
